(19) United States
(12) Patent Application Publication
(10) Pub. No.: US 2010/0176760 A1
(43) Pub. Date: Jul. 15, 2010

(54) SYSTEM FOR PHOTOVOLTAIC POWER AND CHARGE MANAGEMENT

(76) Inventor: M. JAMES BULLEN, Los Gatos, CA (US)

Correspondence Address: HAYNES AND BOONE, LLP;IP Section, 2323 Victory Avenue, Suite 700, Dallas, TX, 75219, US

(21) Appl. No.: 12/351,105

(22) Filed: Jan. 9, 2009

(51) Int. Cl. H02J 7/00

(52) U.S. Cl. 320/101

(57) ABSTRACT

A charging system for an intelligent consumer device is presented. The charging system includes a monitoring program executed by the intelligent consumer device that displays data related to the charge state of a battery pack. An intelligent charger provides solar generated power and data to the intelligent consumer device regarding performance of the solar panel. The power management application may be downloaded to the intelligent consumer device from the internet.

### BACKGROUND

1. Field of the Invention

The present invention relates to power and charge management and, in particular, to managing the charging of batteries in consumer electronics devices.

2. Discussion of Related Art

Several manufacturers of consumer electronic devices have recently offered a development platform for third-party development of applications. For example, Apple's iPhone 3G™ allows for third party applications that are typically deployed on a web server attached to the World Wide Web (WWW). These applications are accessible from the WWW with an ordinary browser. A variety of methods are employed to download the software onto the consumer electronic device.

One aspect of consumer electronic devices that is particularly important to the user is battery lifetime. Proper power management allows for extended use of the device. Often, such devices are recharged frequently in order to maintain sufficient battery charge for operation.

Therefore, there is a need for devices that charge and maintain batteries on consumer electronics devices.

### SUMMARY

Consistent with the present invention, a power management system is presented. An intelligent charger consistent with the present invention includes a solar panel; a connector; monitor and control electronics coupled to the solar panel, the monitor and control electronics conditioning power from the solar panel, monitoring performance characteristics of the solar panel, and providing power to the connector to charge a battery pack of an intelligent consumer device connected to the connector; and a microprocessor coupled to the monitor and control electronics and the connector, the microprocessor receiving data from the monitor and control electronics and providing data to the intelligent consumer device through the connector.

A power monitoring system consistent with the present invention includes an intelligent consumer device including a microprocessor, a battery pack, a display, and a connector, the microprocessor executing software code that receives performance data from an intelligent charger, the intelligent charger including a solar panel to provide charging current to the battery pack; monitors charging of the battery pack to obtain charging data; and displays performance data charging data on a program monitor dashboard on the display.

A method of charging an intelligent consumer device consistent with the present invention includes receiving power generated from a solar panel in an intelligent charger; receiving performance data from the intelligent charger; charging a battery pack using the power; monitoring charging of the battery pack to obtain charge data; and displaying the performance data and the charge data on a power monitor dashboard.

These and other embodiments consistent with the present invention are further discussed below with reference to the following figures.

### BRIEF DESCRIPTION OF THE FIGURES

FIG. 1 illustrates a networking environment in which embodiments of a system consistent with the present invention can function.

FIG. 2A illustrates a block diagram of an intelligent charger consistent with some embodiments of the present invention.

FIG. 2B illustrates a block diagram of an intelligent user device that can be utilized with the intelligent charger shown in FIG. 2A.

FIG. 2C illustrates an intelligent charger and an intelligent consumer device consistent with some embodiments of the present invention.

FIG. 3 illustrates a database of application products consistent with aspects of the present invention.

FIG. 4 illustrates applications applicable with systems according to the present invention.

FIG. 5 illustrates an intelligent charger in communication with an intelligent consumer device executing a power management application consistent with embodiments of the present invention.

FIG. 6 illustrates an embodiment of a power management dashboard on an intelligent consumer device consistent with the present invention.

FIG. 7 illustrates the amount of solar radiation that can be captured by a system consistent with the present application over a day.

FIG. 8 shows an embodiment of a configuration menu on the Intelligent User Device consistent with the present invention.

In the figures, elements having the same or similar functions have the same designation.

### DETAILED DESCRIPTION

Most consumer devices today suffer from a common consumer complaint—inadequate battery power. Embodiments of the invention include an intelligent charger for the consumer device. The intelligent charger may contain an auxiliary battery, a solar system for generating electricity, a microprocessor, and software for management of the intelligent charger in the consumer device environment.

Some embodiments of the present invention integrate a photovoltaic system with an intelligent consumer device (ICD) to manage the power requirements of the device. This integration can be achieved by software operating on the ICD and an intelligent charger that physically or logically connects to the consumer device. The software can be downloaded using the World Wide Web in some manner so that it runs on the ICD, or may be supplied with the ICD.

Successful ICDs typically provide a rewarding experience for the consumer, in both form and function. In some embodiments, the intelligent charger can be aesthetically pleasing and can provide users with a complete set of functions directed towards power and charge management of the ICD. Together, the intelligent charger and the ICD can include, among other things, a battery pack, a solar system, one or more microprocessors, a physical connection, and a presentation platform in which to interact with the user.

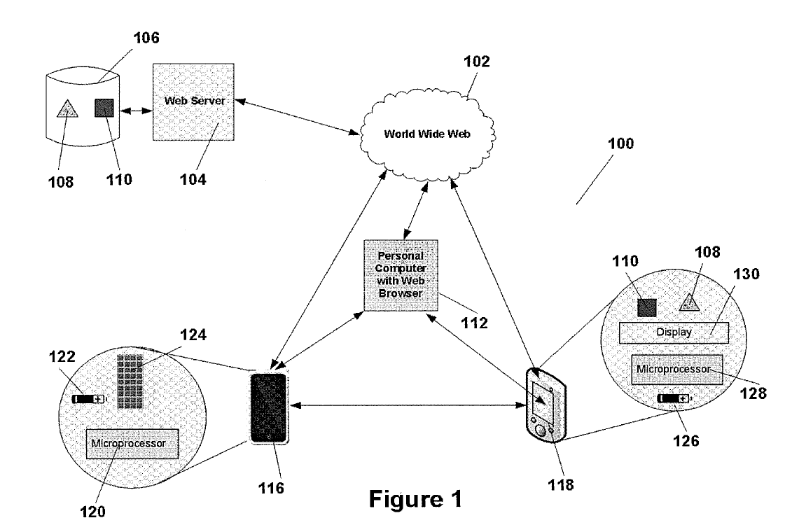

FIG. 1 illustrates a network environment 100 in which some embodiments consistent with the present invention may operate. As shown in FIG. 1, an intelligent charger 116 can communicate with an ICD 118. Intelligent charger 116 can also communicate with a personal computer 112 that is in communication with the World Wide Web WWW 112. A web server 104 with a database 106 containing power management applications 110 and objects 108 that may represent the embodiment of a particular user (avatars) is also coupled to WWW 102.

Web Server 104 can be a standard computer with a database 106 that includes avatars 108 and applications 110. Web server 104 is coupled to WWW 102, which is accessible by any computer system executing a browser application and connected to WWW 102. Personal computer 112 is coupled to WWW 102 and includes a browser application that allows it to download avatars 108 and applications 110, which may be stored on a storage medium such as a magnetic hard drive coupled to personal computer 112. Personal computer 112 may also be capable of uploading material through WWW 102 to web server 104 for storage on database 106. Material that could be uploaded for storage on database 101 may include avatars, which may be stored in a -.avi or -.wav format, or applications. Web server 104 may represent any number of servers on which applications and avatars that are compatible with ICD 118 are stored.

As further shown in FIG. 1, ICD 118 can be coupled to personal computer 112. Using the web browser resident on personal computer 112, applications 110 and avatars 108 can be downloaded onto ICD 118. Users may also publish avatars for general use by others by uploading applications and avatars to web server 104. Among the applications that may be downloaded from database 106 is a power management application, which can then be installed on ICD 118. Intelligent charger 116 can also be connected to ICD 118. When ICD 118 and intelligent charger 116 are connected, and ICD 118 is executing the power management application, intelligent charger 116 can transfer power and charge management information to the power management application running on ICD 118.

As shown in FIG. 1, personal computer 112 interfaces with ICD 118. The interface between personal computer 112 and ICD 118 can be through a physical connector, or may be wireless such as with a Bluetooth communications port. Applications and avatars, such as avatars 108 and applications 110, for example, downloaded from database 106 can then be transferred to ICD 118. As shown in FIG. 1, ICD 118 includes a battery pack 126 with one or more batteries, a microprocessor 128, which includes memory for storing programs and data, may include a user interface such as a keyboard for receiving input from a user, and a display 130. Applications 110 and avatars 108 received from data base 106 can be stored and executed on ICD 118. As further shown in FIG. 1, ICD 118 may be capable of interacting with the WWW 102 directly without the need to be coupled with person computer 112, in which case applications 110 and avatars 108 may be downloaded to ICD 118 directly from WWW 102.

As further shown in FIG. 1, intelligent charger 116 can also be coupled to both personal computer 112 and ICD 118. Such communication can be performed through physical connections or wirelessly, for example utilizing a Bluetooth or other such standard for wireless communications. Intelligent charger 116 can include a solar panel 124, backup battery pack 122, and microprocessor 120. Intelligent charger 116 can generate statistics and pass the statistics to ICD 118 through connector 114. A power monitoring application operating on ICD 118 can then receive the data from intelligent charger 116.

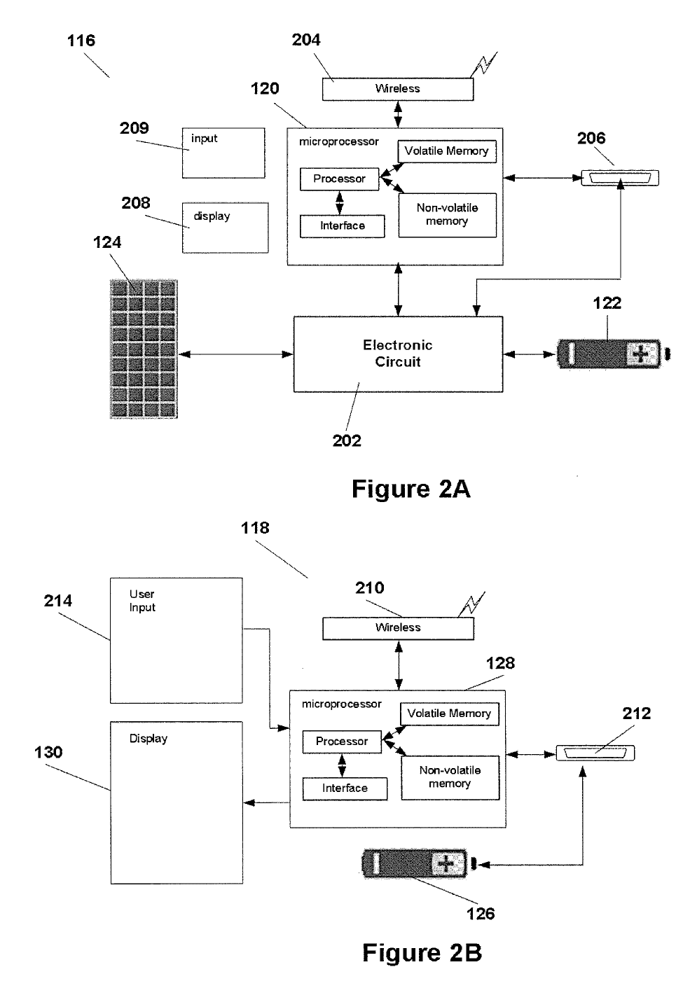

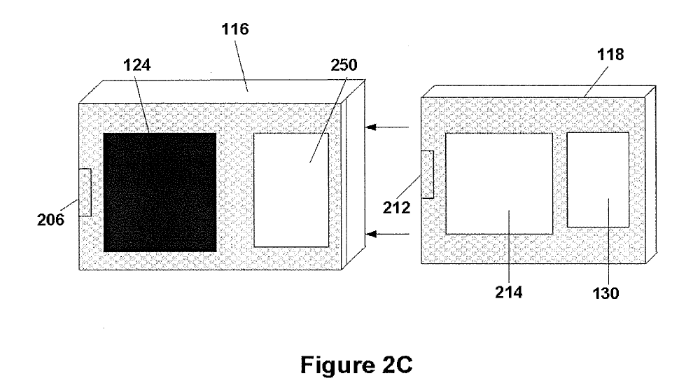

FIG. 2A illustrates a detailed diagram of an embodiment of intelligent charger 116 consistent with the present invention. As discussed above, intelligent charger 116 includes a solar panel 124, a battery pack 122, and a microprocessor 120. As shown in FIG. 2A, microprocessor 120 can include a processor, volatile and non-volatile memory, and an interface. Programming and operating parameters can be stored in non-volatile memory while operating parameters and interim results can be stored in volatile memory. The interface allows microprocessor 120 to communicate, for example with wireless transceiver 204, physical connector 206, and electronic circuit 202. In some embodiments, intelligent charger 116 may include a display 208 and may further include a user input device 209 in order to communicate with a user.

As shown in FIG. 2A, microprocessor 120 is coupled to electronic circuit 202. Electronic circuit 202 is coupled to solar panel 124 and battery pack 122. In some embodiments, electronic circuit 202 may use one of a number of transformer technologies (boost, buck, Cuk, etc.) for power management of the output current and voltage to be compatible with battery 122 based upon incoming current and voltage from solar panel 124. Battery 122 can be any rechargeable battery, but in some embodiments is a lithium-ion polymer. Electronic circuit 202 is also coupled to physical connector 206 in order to provide a charging current and voltage to IDC 118 when IDC 118 is coupled to connector 206.

Electronic circuit 202 is coupled to microprocessor 120, which stores and executes charge management software. The charge management software operating on microprocessor 120 ensures that battery pack 122 and any battery coupled to connector 114 receives current and voltage appropriate to charge those batteries. As such, electronic circuit 202 receives power from solar panel 124 and converts that power to voltage and current appropriate to charge battery pack 122. Electronic circuit 202 may also convert power to voltage and current appropriate to charge battery pack 126 in ICD 118 when ICD 118 is coupled to intelligent charger 116.

In some embodiments, electronic circuit 202 also includes monitoring electronics to monitor the power output and status of solar panel 124 as well as the charge and status of battery 122. In some embodiments, electronics 202 can also monitor the charge and status of a battery in ICD 118 through connector 206. Microprocessor 120, then, can monitor and provide statistics on, for example, power production in solar panel 124, temperature, and battery charging. Those statistics may be accessible to ICD 118.

As shown in FIG. 2A, intelligent charger 116 may also include a wireless transceiver 204 that is coupled to microprocessor 120. Wireless transceiver 204 may include a cell phone transceiver and may be capable of communicating directly with WWW 102. In some embodiments, wireless transceiver 204 may include a local transceiver such as, for example, a Bluetooth transceiver. In which case, intelligent charger 116 can communicate wirelessly with IDC 118 or to personal computer 112 through wireless transceiver 204.

In some embodiments, information regarding charging or discharging of battery 122 may be displayed on display 208. In some embodiments, ICD 118 may communicate information to electronic circuit 202 that may then be displayed on display 208.

FIG. 2B illustrates a typical ICD 118. ICD 118 may be any portable electronic computing device such as, for example, the Apple iPhone, a Blackberry, or any other such device. Typically, ICD 118 includes a microprocessor 128, a display 130, and a user input 214. Microprocessor 128 includes a processor, volatile and non-volatile memory, and an interface. Microprocessor 128 executes applications that are stored in non-volatile memory in response to user requests initiated through user input 214. Further, microprocessor 128 displays information on display 130. Microprocessor 128 may be coupled through a physical connector 212 for communications with other devices, for example intelligent charger 116 or personal computer 112. Further, microprocessor 128 is also coupled to a wireless transceiver 210. Wireless transceiver 210 can utilize a cell phone technology so that ICD 118 operates as a cell phone. Furthermore, wireless transceiver 210 can include short-range wireless communications such as Bluetooth, for example. Through wireless transceiver 210, ICD 118 can communicate directly with WWW 102. Further, ICD 118 can be coupled to personal computer 112 through a Bluetooth connection in wireless transceiver 210, or through physical connection 212.

Intelligent charger 116 can communicates with ICD 118 or to personal computer 112, which is connected to WWW 102, using industry standard protocols like SNMP (simple network management protocol, an application protocol of TCP/IP). In typical SNMP usage, there are systems to be managed, and one or more systems managing them. For example, a software component called an agent can be executed on intelligent charger 116 which reports information via SNMP to managing systems operating, for example, on ICD 118. Charger 116 can report this information using wireless interface 210 or connector 112. Other communications protocols may be used and other interface mechanisms may be used.

ICD 118 is powered by battery pack 126, which may include one or more rechargeable batteries such as lithium-ion polymer batteries. Battery pack 126 is typically recharged through physical connector 212. Further, microprocessor 128 may include circuitry and applications to monitor the charging of battery pack 126. Although illustrated in FIGS. 2A and 2B as a single physical connector, physical connectors 206 and 212 may be implemented with multiple physical connector plugs.

In some embodiments, intelligent charger 116 can provide a protective case for ICD 118. In which case, intelligent charger 116 physically receives and holds ICD 118. Further, connector 206 of intelligent charger 116 is compatible with connector 212 of ICD 118 so that ICD 118 plugs directly into intelligent charger 116. Therefore, applications such as a power management application that is being executed on microprocessor 128 can communicate with microprocessor 120 of intelligent charger 116.

FIG. 2C illustrates intelligent charger 116 as a protective case into which ICD 118 can be inserted. As shown in FIG. 2C, connector 212 mates with connector 206 when IDC 118 is inserted into intelligent charger 116. In some embodiments, a window 250 in intelligent charger 116 is provided so that display 130 can be viewed through intelligent charger 116. In some embodiments, ICD 118 is positioned in intelligent charger 116 so that display 130 and user input 214 are opposite solar panel 124 and are accessible through the side of intelligent charger 116 opposite to the side shown in FIG. 2C.

As shown in FIG. 1, applications 110 and avatars 108 can be downloaded into microprocessor 128 through WWW 162 from database 106 through web server 104. Such downloads can be accomplished in any way, for example through a direct connection through wireless interface 210 to WWW 162 or through personal computer 112 through physical connector 212. One set of applications that can be downloaded allows ICD 118 to communicate with and control intelligent charger 116 when ICD 118 and intelligent charger 116 are coupled.

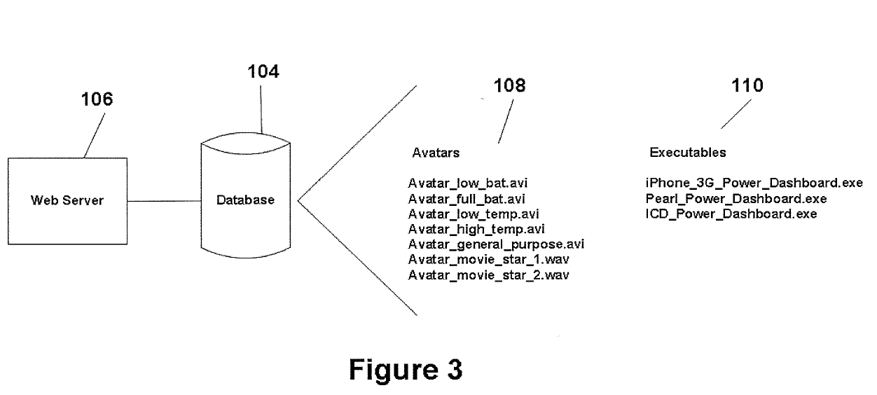

FIG. 3 illustrates avatars 108 and applications 110 that may be stored in database 104 and which are available for download to ICD 118. Each of avatars 108 can be downloaded to ICD 118 and can be utilized to indicate specific situations that arise on ICD 118. As shown in FIG. 3, avatars 108 are available to depict low or full battery, low or high temperature, and other situations for entertainment or esthetic purposes. Avatars 108 can be played whenever a situation exists where the user needs or wants to see information. An example of this would be a low battery in ICD 118. If a low battery condition occurred the appropriate avatar would be played. In some embodiments, avatars can include video, graphics, text and sound in any combination. It is possible for an avatar to be general purpose and therefore a requirement for specific text (as in “Low Battery”) can scroll across or be displayed on display 130 of ICD 118.

Applications 110 may be specific to ICD 118. For example, if ICD 118 is an iPhone 3G, then applications specific to the iPhone 3G (e.g., iPhone_{—}3G_Power_Dashboard.exe) should be downloaded. If ICD 118 is a Pearl, then applications specific to the Pearl (e.g., Pearl_Power_Dashboard.exe) should be downloaded. Applications 110 include programming instructions that, when executed by ICD 118, allow ICD 118 to communicate with intelligent charger 116 and monitor power management of ICD 118 and intelligent charger 116.

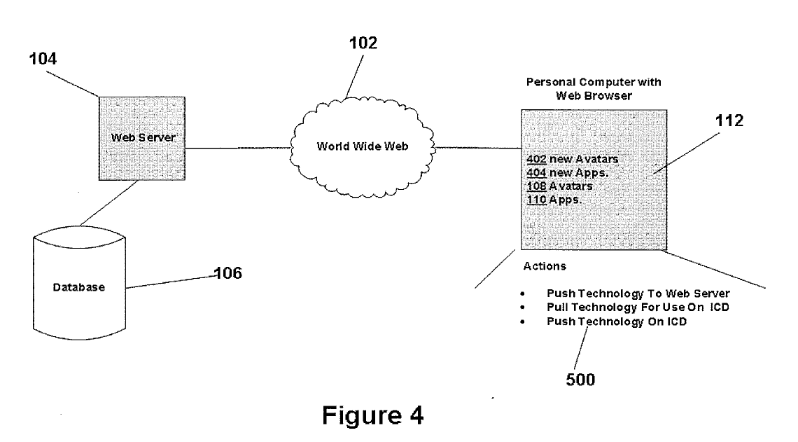

FIG. 4 illustrates personal computer 112. Personal computer 112 executing a web browser can be used to interface with the Web Server 104 through WWW 102. Personal computer 112 may perform any number of actions 500. One action 500 can be to “push” technology to web server 104. An example of a push action would be to upload new avatars 402 and new applications 404 to web server 104 for storage on database 106, which may then be downloaded as avatars 108 and applications 110. In practice, avatars 402 and applications 404 that are to be uploaded would be placed in a test area of web server 104 where they would be tested and otherwise verified to perform as designed before being stored as avatars 108 and applications 110. New applications 402 and avatars 404 may be developed on personal computer 112 or, in some embodiments, developed on ICD 118.

A second action performed by personal computer 112 would be to “pull” technology for download to the ICD 118. In this fashion, avatars 108 and applications 110 can be moved from database 106 onto personal computer 112 and then downloaded onto ICD 118 from personal computer 112. In this case, ICD 118 is coupled to personal computer 112 either through physical connector 212 or wirelesses through wireless transceiver 210.

As discussed above, in some embodiments ICD 118 may be capable of performing “push” and “pull” operations through WWW 102 directly so that avatars 108 and applications 110 may be directly downloaded onto ICD 118. Furthermore, new avatars 402 and new applications 404 that are created by a user on ICD 118 may be directly uploaded onto web server 104.

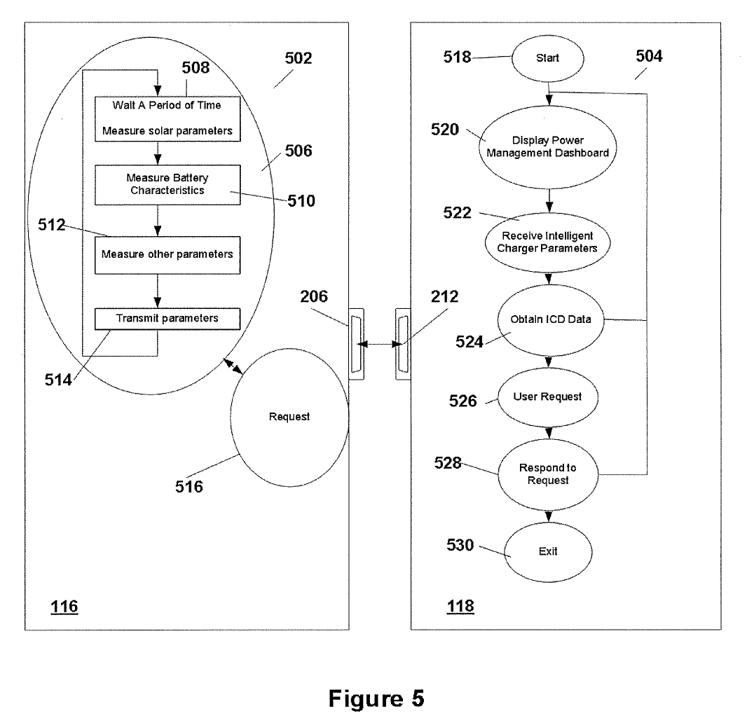

FIG. 5 illustrates operation of an embodiment of intelligent charger 116 in communications with an ICD 118 that is executing a power management application 504 consistent with embodiments of the present invention. Power management application 504 is one of applications 110 downloaded to ICD 118 from web server 104, as discussed above.

As shown in FIG. 5, intelligent charger 116 executes an application 502 while ICD 118 executes an application 504. In the embodiment shown in FIG. 5, physical connector 206 of intelligent charger 116 is mated with physical connector 212 of ICD 118, although in some embodiments data and requests can also be exchanged wirelessly between intelligent charger 116 and ICD 118. Application 502 may also be downloaded to intelligent charger 116 from web server 104.

Applications 502 operating on intelligent charger 116 and application 504 operating on ICD 118 cooperatively operate to monitor and manage recharging batteries both on intelligent charger 116 and on ICD 118. Application 502 includes measurement state 506 where parameters related to solar panel 124 and battery pack 122 are obtained and transmitted to ICD 118. Alternatively, the power management dashboard may be displayed on display 208 of charger 116. As shown in FIG. 5, state 506 includes the steps of measuring solar parameters 508, measuring battery characteristics 510, and measuring other parameters 512 before a transmit step 514. Solar parameters measured in step 508 can, for example, include an instantaneous solar power and an accumulation of solar energy. Battery characteristics measured in step 510 can, for example, include determination of a battery charge state and determination of a time to full charge of the battery. Other parameters that are measured in step 512 may, for example, include temperature information of battery pack 122 or of solar panel 124. These parameters can then be transmitted to ICD 118 in step 514. Further, state 506 may be interrupted by ICD 118, causing a transition to state 516 in order that specific parameters be measured and sent at the request of application 504 executing on ICD 118.

While application 502 is executing on intelligent charger 116, application 504 is executing on ICD 118. Application 504 begins with a start step 518 which is initiated by a user. Once started, application 504 displays a power management dashboard in step 520. The power management dashboard can be displayed on display 130 of ICD 118. The power management dashboard can be utilized to display parameters such as the solar parameters, battery characteristics, and other parameters received from intelligent charger in step 522. Further, parameters regarding the state of charge and recharge time of battery pack 126 that is obtained in step 524 of application 504 can be displayed.

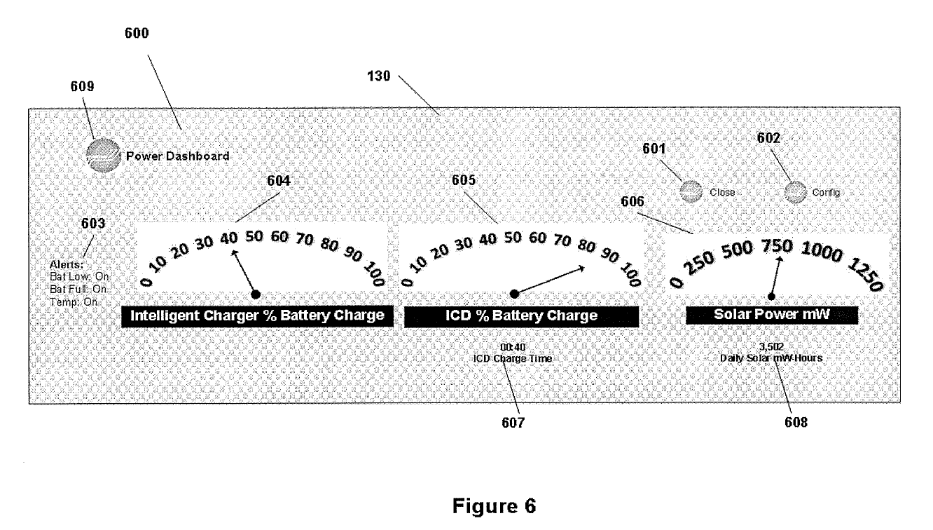

FIG. 6 illustrates an embodiment of a power management dashboard 600 displayed on display 130 in step 520 of power management application 504. Power management dashboard 600 can show several parameters, including the status of alerts, the state of charge and charge time of battery pack 122 in intelligent charger 116, the state of charge and charge time of battery pack 126 in ICD 118, the incident solar energy received by solar panel 124 of intelligent charger 116, and a total of solar energy received by solar panel 124 over a period of time. In some embodiments, power management application 504 may capture and hold data for display. In that fashion, power fluctuations that may occur when the user is viewing the dashboard may not be displayed on the dashboard.

The user is able to enter start 518 of power management application 504 by choosing an icon designating power management application 504 on a menu of ICD 118. In some embodiments, power management application 504 may be initiated by charger 116 in response to input from user input 209. After start step 518, power management dashboard 600 may be launched. Several icons that can be activated by the user can be displayed on power management dashboard 600. For example, close icon 601 and configure icon 602 are shown in FIG. 6. Other icons such as icon 609 may also be utilized to request performance of other tasks. As indicated, power management application 504 can proceed to exit step 530 when close icon 601 is activated. Further, power management application 504 can proceed to step 528 when configure icon 602 is activated. The status of real time alarms can be displayed in alerts 603. Some alarms that may be set include low battery alarm that indicates when battery pack 122 is low, full battery alarm that indicates when battery pack 126 is full, and a temperature alarm which indicates whether a component of intelligent charger 116 or ICD 118 is overheating. Alerts 603 can indicate whether or not the real time alarms are set. The alarms may be audible or visual in nature. Further, power management dashboard 600 may include an intelligent charger battery charge indicator 604, a ICD battery charge indicator 605, and a solar power indicator 606. Solar power indicator 606 may be an average power gauge or an instantaneous power gauge. Although indicators 604, 605, and 606 are shown as meters, this information may be displayed in any fashion, including graphically or digitally. Further, other information may be provided. For example, the example power management dashboard 600 also displays estimated charge time for battery pack 126 and total solar power received 608.

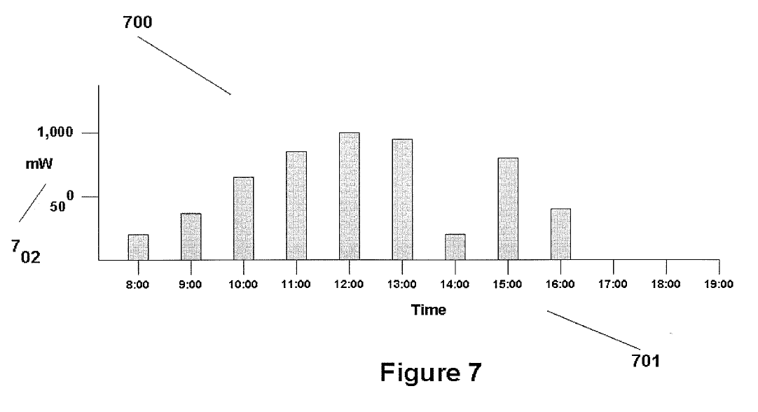

FIG. 7 illustrates another presentation of incident solar power 700 which may be displayed on power management dashboard 600. Presentation 700 is a bar chart of the solar power received during any given hour. The y-axis 702 is in mW and the x-axis 701 is in time. One skilled in the art will recognize various other methods of displaying information on power management dashboard 600.

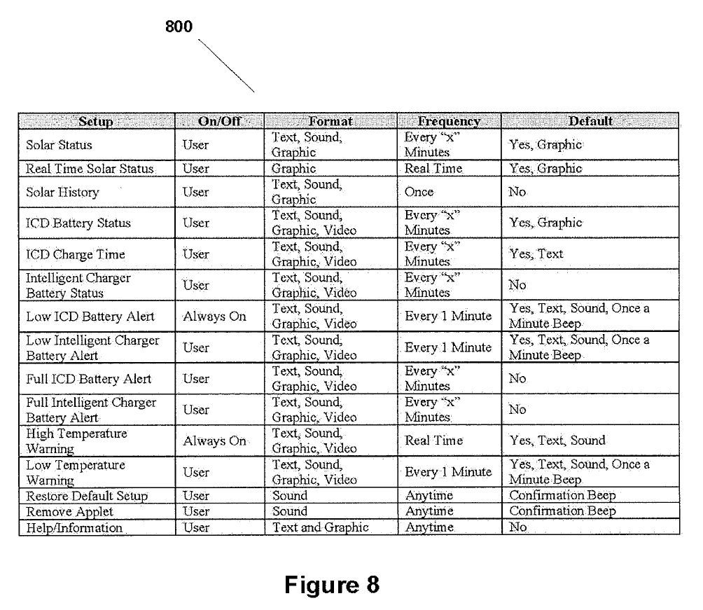

FIG. 8 illustrates an embodiment of a configuration menu 800 on ICD 118 consistent with the present invention. The configuration menu can be displayed on display 130 in step 528 when a user activates configuration icon 602 on power management dashboard 600. The configuration menu provides the user with the opportunity to configure a specific activity with a variety of different informational actions. Further, avatars may be configured during configuration.

As shown in FIG. 8, configuration menu 800 can include a list of setup options that are available to the user. In some embodiments, a configuration procedure may be executed that allows the user to select options under each of the headings corresponding with rows in configuration menu 800. The options can include, for example, solar status, real time solar status, solar history, ICD battery status, ICD charge time, intelligent charger battery status, Low ICD battery alert, Low intelligent charger battery alert, Full ICD battery alert, Full intelligent charger battery alert, high temperature warning, low temperature warning, restore default setup, remove applet, and help/information. Many options of configuration menu 800 may be selected as on or off by the user. Some options, for example the low ICD battery alert, may always be on, but the format of the alert may be selected. Selectable formats for the various options are also shown in configuration menu 800. For example, alerts or status information may be presented to the user in audio format (speech), textually, graphically, or through video. Depending upon user criteria, different selections may be made. For some of the setup options (restore default setup and remove applet) there are no selection criteria. Those selectable options are not applicable to presentation of information on power management dashboard 600. For others, for example real time solar status and Help/Information, there may be a specific configuration picked as they are displayed in a specific format. If a user picks an option such as a video to play for a specific setup option and a corresponding avatar, video, or sound clip can not be found on ICD 118, then the user may be asked to pick another setup option.

The frequency at which information is updated on power management dashboard 600 may also be selected by the user. In some cases (for example, real time solar status and high temperature warning) the information can be provided to the user in real time, all the time. In other cases (for example, restore default setup, remove applet, and Help/Information) the information may be invoked anytime at the discretion of the user. In yet other cases (low ICD battery and low intelligent charger battery), frequency of update may be set in specific, for example 1 minute, intervals. In some cases, the frequency of update may be set to an integer number of specific time units, for example to every “x” minutes where “x” is any integer value from 1 to 10.

Further, configuration menu 800 illustrates default options. These options are set in advance and, unless changed by the user, will determine the operation of ICD 118. Further, these options will be selected if the user elects to restore defaults during a configuration operation in step 528 of application 504.

Intelligent Charger 116 can store the solar energy that it receives in battery pack 122. When mated with the ICD 118 as shown in FIG. 5, the energy stored in battery pack 122 of intelligent charger 116 can be transferred to battery pack 126 of ICD 118. Further, in some embodiments intelligent charger 116 can monitor the charging of battery pack 126 and provide information about the time to charge the battery if left undisturbed along with the solar power being received. In some embodiments, the charging of battery pack 126 can be monitored by ICD 118. Additional information about the temperature of components of intelligent charger 116 can also be collected by intelligent charger 116 and transferred to ICD 118 when intelligent charger 116 and ICD 118 are coupled.

ICD 118 executes the power management application 504, which displays the power management dashboard, when requested by the user. In some embodiments, power management application 504 may also be initiated when an event occurs that requires the attention of the user, for example if the charge on battery pack 126 becomes low or a temperature event occurs. In some embodiments, power management application 504 may execute whether or not intelligent charger 116 and ICD 118 are coupled. ICD 118 may display information utilizing power management dashboard 600, absent data that is typically received from intelligent charger 116. If ICD 118 is not connected with intelligent charger 116, then battery pack 126 will not be charged. The information displayed by ICD 118 will be truncated accordingly.

Application 504 may act on information obtained by monitoring circuitry in ICD 118 itself. When connected, there would be information transfer from intelligent charger 116 to ICD 118 and that information displayed on power management dashboard 600 as well.

Power and charge management application 504 that can operate on ICD 118 can be available from third party providers of applications and downloaded from web server 104, which is operated by the third party. Application 504 then operates with intelligent charger 116 in order to monitor and manage the charging of battery pack 126 or in supplying power to operate intelligent charger 116 directly.

Power and management application 504, which operates with application 502 operating on intelligent charger 116, complements use of ICD 118 and improves the power and charge management of ICD 118. Utilizing of intelligent charger 116, with solar panel 124, may allow long-term use of ICD 118. Application 504, through display on power management dashboard 600, may allow the user to monitor information, alerts, and statistics regarding the power usage of ICD 118 as well as the charging of battery pack 126 by intelligent charger 116.

Further, value added calculations and presentation of data by application 504 enhances the user experience with ICD 118. Custom configuration through configuration menus such as configuration menu 800 allows the user to personalize ICD 118. In some cases, application 504 allows customization with fourth party icons, avatars, audio objects, or other materials. For example a W.C. Fields avatar could be created to alert a user that battery pack 126 or battery pack 122 is too low. In some embodiments, components of application 504 may be open source software, which allows for easier development by developers. In some embodiments, specific specifications that allow fourth party developers to develop objects such as avatars or sound objects can be freely published.

Exemplary embodiments consistent with the present invention are disclosed above. One of skill in the art will recognize numerous variations from the embodiments specifically described. Those variations should be considered to be within the scope of this disclosure. As such, the invention should be limited only by the following claims.

What is claimed is:

1. An intelligent charger, comprising:
a solar panel;
a connector;
monitor and control electronics coupled to the solar panel, the monitor and control electronics capable of conditioning power, monitoring performance characteristics of the solar panel, and providing power to the connector to charge a device battery pack of an intelligent consumer device connected to the connector; and
a microprocessor coupled to the monitor and control electronics and the connector, the microprocessor receiving data from the monitor and control electronics and providing data to the intelligent consumer device through the connector.

2. The charger of claim 1, further including a charger battery pack and wherein the monitor and control electronics is further coupled to the charger battery pack, the monitor and control electronics capable of monitoring the charger battery pack, charging the charger battery pack, and utilizing power from the charger battery pack to charge the device battery pack.

3. The charger of claim 2, wherein the charger can be coupled to a personal computer to receive programming.

4. The charger of claim 3, wherein the charger can be coupled to the personal computer through the connector.

5. The charger of claim 3, wherein the charger can be coupled to the personal computer through a wireless connection.

6. The charger of claim 1, wherein the charger can communicate with the intelligent consumer device through a wireless connection.

7. The charger of claim 1, wherein the charger is arranged to receive and hold the intelligent consumer device.

8. The charger of claim 7, wherein the charger includes a window aligned with a display on the intelligent consumer device.

9. The charger of claim 1, further including a display.

10. The charger of claim 9, wherein the microprocessor displays information received from the intelligent consumer device on the display.

11. A power monitoring system, comprising
an intelligent consumer device including a microprocessor, a device battery pack, a display, and a connector, the microprocessor executing software code that
receives performance data from an intelligent charger, the intelligent charger including a solar panel and providing charging current to the device battery pack;
monitors charging of the device battery pack to obtain charging data; and
displays performance data and charging data on a program monitor dashboard displayed on the display.

12. The system of claim 11, wherein the intelligent consumer device can coupled with a personal computer to receive and store the software code.

13. The system of claim 11, wherein the intelligent consumer device includes a wireless transceiver through which the software code can be received from a web server.

14. The system of claim 11, wherein the performance data includes solar data for a solar panel.

15. The system of claim 11, wherein performance data includes charging data for a charger battery pack on the intelligent charger.

16. The system of claim 11, wherein performance data includes temperature data.

17. The system of claim 11, wherein performance data is updated in a set time.

18. The system of claim 17, wherein the set time is determined in a configuration table.

19. The system of claim 11, wherein at least a portion of the performance data is communicated to the intelligent charger for display on the intelligent charger.

20. A method of charging an intelligent consumer device, comprising:
receiving power generated from a solar panel in an intelligent charger;
receiving performance data from the intelligent charger;
charging a battery pack using the power;
monitoring charging of the battery pack to obtain charge data; and
displaying the performance data and the charge data on a power monitor dashboard.

21. The method of claim 20, further including
transferring at least a portion of the performance data to the intelligent charger;
displaying the portion of the performance data on the intelligent charger.

22. The method of claim 20, further including
communicating with a network to receive instructions for execution on the intelligent consumer device.
